(19) United States
(12) Patent Application Publication
(10) Pub. No.: US 2014/0285523 A1
(43) Pub. Date: Sep. 25, 2014

(54) Method for Integrating Virtual Object into Vehicle Displays

(71) Applicant: Daimler AG, Stuttgart (DE)

(72) Inventors: Christian Gruenler, Ergenzingen (DE); Jens Ruh, Filderstadt-Bernhausen (DE)

(21) Appl. No.: 14/350,755

(22) PCT Filed: Sep. 28, 2012
(86) PCT No.: PCT/EP2012/004071

§ 371 Date: Apr. 9, 2014

(30) Foreign Application Priority Data
Oct. 11, 2011 (DE) 10 2011 115 739.9

(51) Int. Cl. B60R 1/00; G06T 19/00

(52) U.S. Cl. CPC B60R 1/00; G06T 19/006; B60R 2300/107; B60R 2300/308
USPC 345/633

(57) ABSTRACT

A method for the depiction of virtual objects in vehicle displays using one of at least one digital image of a defined real 3D object space recorded by a camera involves generating a virtual course of the road by retrieving perspective information from the digital image of the defined real 3D object space. A pre-determined virtual 3D object is then generated, which is subsequently adapted to the virtual course of the road of the defined real 3D object perspectively and with spatial accuracy. The adapted virtual 3D object is then integrated into the virtual course of the road of the defined real 3D object space.

### BACKGROUND AND SUMMARY OF THE INVENTION

Exemplary embodiments of the invention relate to a method and a device for the perspective depiction of an artificial or virtually generated 3D object on a 2D display device.

The depiction of three-dimensional geometries or of three-dimensional objects or scenes with the aid of computer systems currently plays a significant role in numerous applications. With the aid of the three-dimensional depiction, real situations can be simulated, for example in flight simulators. A further application example of three-dimensional depictions is typical in architecture, wherein here—by means of simulation of three-dimensional spaces—a representation of the sites in a virtual building is enabled.

German utility model document DE 203 05 278 U1 discloses a device for the depiction of 3D objects on a 2D display device in which the 3D objects can be depicted with consideration for an observer position that can change with respect to the 2D display device. The observer position can be determined by means of a position detection device. Several cameras are used to detect the position of the observer or the observed object. Thus, a realistic spatial impression is lent to an actual 2D depiction.

Computer-supported augmentation of the perception of reality, wherein images or videos are supplemented with computer-generated additional information or virtual objects by means of overlay, is commonly referred to by the term “augmented reality”.

It is now also possible to augment 2D images with perspectively correct, integrated virtual objects that provide additional information. This new development is also implemented in connection with augmented reality. The first research prototypes, as well as commercially-available solutions that are integrated onto smart phones, implement such developments to some degree. As part of these existing solutions, additional information is overlaid into a video image depending on a spatial position and location of a camera.

However, a wireless integration of virtual objects with the correct level of overlap is not possible with image synthesis based solely on 2D information. On the one hand, the perspective of the overlays often does not match the perspective of the camera image and, on the other hand, overlaid virtual objects permanently overlap the depiction of the back-ground of the camera images, even if real objects are closer than the overlays. In other words, real and virtual objects are not superimposed correctly on the reproduced image of a display device.

Exemplary embodiments of the present invention are directed to a method and a device that realistically integrates virtual 3D objects into a 2D object.

As has already been mentioned, a wireless integration of virtual 3D objects with the correct level of overlap is not possible with image synthesis based solely on 2D information. A correct synthesis of real and virtual 3D objects in which virtual and real 3D objects are depicted with the correct level of overlap with respect to one another can only take place by merging of the objects in the three-dimensional space.

For the depiction of virtual 3D objects—for example in vehicle displays—the method according to the invention uses a recorded digital image of a defined real 3D object space, as well as the depth information for each pixel belonging to the recorded digital image.

The depth information contains a three-dimensional description of the vehicle environment. In the method according to the invention, it enables, in a first step, perspective information to be retrieved from the digital image of the defined real 3D object space. This occurs, for example, by objects such as the course of the road being detected and a virtual course of the road being generated.

To enrich the scenery with additional information, in a second step of the method, at least one pre-determined virtual 3D object is generated. This can, for example, be a directional arrow, a road sign or traffic information etc. The generated virtual 3D object is then, in a third step of the method in the defined 3D object space, placed perspectively and with positional accuracy in the scenery. This can, for example, take place depending on known objects, such as the virtual course of the road. In addition to the spatial orientation of the virtual 3D object, a perspective and true-to-scale adaptation of the virtual 3D object takes place.

Advantageously, in a preferred embodiment, the virtual course of the road serves, during the generation of the virtual 3D object, as an orientation or referential system for determining a spatial location of the virtual 3D object to be overlaid.

In this step, spatial coordinates for a subsequent superimposition/depiction on a display device is allocated to the individual pixels that represent the generated virtual 3D object. Furthermore, depth values are allocated to the individual pixels that represent the generated virtual 3D object.

Then, in a fourth step of the method, the adapted virtual 3D object is integrated into the recorded image of the real 3D object space.

A relative position of the vehicle with respect to objects in its surroundings can be recorded particularly simply by means of both vehicle-specific cameras. For example, in an advantageous embodiment, directional arrows for navigation can thus be generated with perspective accuracy and marked on a road, wherein they are overlaid in front of the vehicle as flat objects onto a plane that lies parallel to the road, for example as a “red carpet”. Furthermore, in a particularly advantageous embodiment, the lane that is presently used is highlighted by color, wherein it is laid as a three-dimensional, flat band over the model of the detected street and the lanes thereof.

In a particularly preferred embodiment of the invention, in a further step of the method, a virtual environmental model of the defined real 3D object space is synchronized with the virtual course of the road from the first step of the method. A conventional example of a virtual environmental model of the defined real 3D object space is information regarding the street topology and geometry that is present in a navigation device of a vehicle. Taking into account the respective vehicle camera position and the base geometry of the road section located in front of the vehicle, which is generated from navigation data, for example, the retrieval of perspective information and the generation of the virtual course of the road can be examined and synchronized. It can thus be guaranteed that the virtual course of the road is correctly generated. Thus, when there are poor visibility conditions or recording conditions for the vehicle-specific cameras, a virtual course of the road can be reliably generated, for example when there is fog, heavy rain or snowfall.

In a particularly advantageous embodiment of the invention, the display of the recorded digital image, together with the virtual 3D object integrated into the virtual road model, is carried out in such a way that the image content is superimposed with a correct level of overlapping on a conventional display device, such as an LCD/TFT display, monitor etc. During the superimposition of the recorded digital image with the adapted and integrated virtual 3D object from the fourth step of the method, the respective depth information of the pixels of the recorded digital image, as well as of the integrated virtual 3D object, is evaluated. Here, for each pixel position, the depth information of the pixel of the digital image is compared to the corresponding pixel of the virtual 3D image that is to be superimposed, wherein only the pixel on the display device is depicted which, from the view of an observer, is closer to the observer. Thus, the superimposition of the image content depicted on the display device is performed with overlapping accuracy.

In a further preferred embodiment, a front view display is used instead of a conventional display device. In this case, on a display field of a translucent front view display, only the virtual additional information of the adapted visual 3D object—which is integrated into the virtual course of the road—has to be superimposed with the real image appearing in the viewing window of the front view display. Also, in this case, for each pixel of the displayed image, it is decided, with the aid of a Z-buffer of the recorded digital image and the virtual 3D object, whether the image pixel is located closer to the observer on the mutual pixel position of the “real image” or virtual 3D object, or not.

In a specific case, in a particularly advantageous embodiment, only the pixels of the adapted virtual 3D object are shown, since only these pixels are also superimposed/overlaid on a display field of a front view display. Here, the third and fourth steps of the method are also implemented for calculating the correct position, perspective and subsequent integration into the virtual course of the road. However, only the virtual 3D object is displayed on the front view display. The particular advantage is that no excess information/graphics—here the virtual course of the road—overloads the view of a driver with artifacts.

In order that the display of the adapted virtual 3D object on the front view display is enabled, display content on the display field of the front view display must correspond to the display content of the recorded digital image of the defined real 3D object space. It is only in this manner that the virtual 3D object can be displayed perspectively and with spatial accuracy on this display field of the front view display with the correct level of overlap.

Preferably, a respective depth value of a pixel of the digital image is used to retrieve perspective information about the digital image. Such depth values are stored in a data storage device, a so-called Z-buffer. With an evaluation of the depth information from the Z-buffer, the method analysis can determine particularly simply and securely which objects/pixels are marked at which point of a scene, and which are superimposed or overlaid.

The virtual course of the road is a result of the retrieval of perspective information from the digital image of the defined real 3D object space. It corresponds to an approximated three-dimensional model for the course of the road and a lane in front of the vehicle, e.g. in the form of a polygon course. In a particularly preferred embodiment, as an alternative or in addition to the step of retrieving perspective information, information regarding the camera position and/or the vehicle environment and/or map data can also be used. The synchronization with the additional information increases robustness against errors in the method.

In a particularly preferred embodiment, a further improvement to reliability while the virtual course of the road is being generated can be achieved by an additional synchronization of the virtual environmental model of the defined real 3D object space taking place with navigation data of the vehicle and/or a further edge detection being carried out. By combining detected edge information with depth information measured in the region of the detected edges, the course of the road, including bends, rises and dips, can be generated. A particular advantage is that the method according to the invention provides a model of the course of the road that can be generated without further extraction or recalibration of the camera position and configuration. Also, a progressing perspective detection, with its potential errors, can thus be dispensed with.

In a further preferred embodiment of the method according to the invention, further virtual 3D objects can be provided. The provision takes place depending on further information sources of the vehicle or other systems, for example a trip computer of the vehicle, environmental data of a navigation system, traffic guidance systems, road signs, etc. Each of the additionally generated virtual 3D objects is, in an advantageous embodiment according to the invention, adapted perspectively and with spatial accuracy to a virtual course of the road and is integrated into it, as well as being displayed with an accurate level of overlap in relation to the virtual course of the road and the individual virtual 3D objects with respect to one another.

The method according to the invention can be integrated into a vehicle-specific device in a particularly advantageous manner. Such a device requires at least two cameras for recording a digital image of a defined real 3D object space. The device according to the invention furthermore has means for the graphical processing of such information, which can be depicted on at least one display device. According to the embodiment, monitors, LCD displays or even front view displays are used here.

### BRIEF DESCRIPTION OF THE DRAWING FIGURES

The invention is illustrated in greater detail below with the aid of an exemplary embodiment.

FIG. 1 shows a flow chart of an embodiment of the method according to the invention.

### DETAILED DESCRIPTION

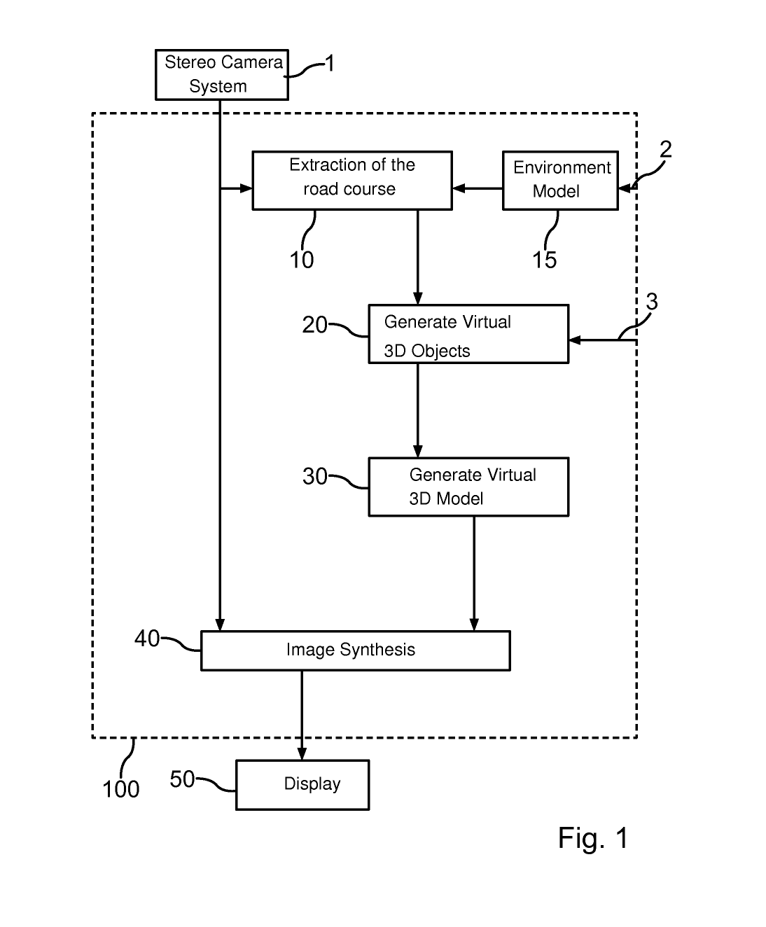

FIG. 1 depicts a flow chart according to one embodiment of the method according to the invention, as is applied, for example, on an augmented reality system 100, which runs on a device according to the invention (not shown) for displaying a digital image of a 3D object space. Such a device can, for example, be provided in a driver assistance system.

A digital image of a defined 3D object space is recorded by two vehicle-specific Cameras—a stereo camera system 1. Here, the real 3D object space corresponds to a cone of vision in the field of vision of a driver. Thus, the stereo camera system 1 provides the necessary raw data for the augmented reality system 100. The raw data comprises a digital, two-dimensional image—monocular image—of the surroundings, wherein depth information is allocated to each pixel of the image. A three-dimensional description of the recorded vehicle environment is possible by means of the depth information.

In a first step of the method, a virtual course of the road 10 is generated. To retrieve perspective information from the digital, monocular image, a Z-buffer is accessed, which contains the depth information of each individual pixel. The result of the retrieval of perspective information is an approximated, three-dimensional model for the course of the road and lane in front of the vehicle, for example in the form of a polygon course. Such a model of the course of the road can be determined without further recalibration of the camera position and camera configuration.

With the aid of edge detection—regarding the edge and center marking of the road in the monocular image—a delineation of the course of the road can be generated. Due to its high level of reliability, this additional method step is used to adapt the determined course of the road and to improve it additionally.

A further increase in accuracy during the retrieval of the course of the road can be achieved by an environmental model 15 of the road being used in a further preferred embodiment. Here, the road topology and geometry can be taken from the navigation data or specific cartographic data of the environmental model 15, which is present in a storage device of the vehicle.

In a particularly preferred embodiment, information originating from the retrieval of the course of the road 10 is combined with data of the environmental model 15. Thus, a highly accurate model of a virtual course of the road is generated, on which bends, rises and dips can be detected. In further preferred embodiments, such method steps can be implemented on their own or in various combinations, in order to generate a virtual course of the road 10 with greater accuracy.

To expand the reality perception in line with the augmented reality system 100 with further information or virtual objects, it is necessary to generate virtual 3D objects. The virtual 3D objects can be, for example, symbols such as arrows or road signs, or indeed text that is to be overlaid. The information sources can be navigation data, card data of an environmental model 15 or information about traffic or parking guidance systems. Also, messages received via radio traffic reports, or messages from a communication terminal such as a smart phone, can trigger or control the generation of 3D objects. Furthermore, information about a driver assistance system can be the basis for objects to be overlaid, such as a safe distance to the car in front, remaining in lanes etc.

To improve the depiction during the display of the generated information—of the virtual course of the road 10 and the generated virtual 3D objects 20—the virtual 3D objects 20 must, in a further step of the method according to the invention, be adapted perspectively and with spatial accuracy. During the generation of a virtual 3D model 30, directional arrows, for example, are adapted to an orientation of the virtual course of the road and are allocated to a specific road section. A further generated, virtual 3D object, for example a road sign, would therefore be allocated to a specific location on the edge of the virtual course of the road and would additionally be adapted perspectively to this.

Then, during image synthesis 40, the adapted virtual 3D objects 30 are integrated into the virtual course of the road 10 of the defined real 3D object space. In this step, depth information is allocated to pixels corresponding to the respective 3D objects. The virtual image 40 now arising corresponds to, for example, a virtual course of the road—a polygon course—in which one or more virtual 3D objects are arranged.

The image synthesis 40 step involves performing a true-to-scale adaptation of the generated virtual 3D objects 20 to the virtual course of the road 10. The scale adaptation can furthermore take place to different extents depending on priority of information. In a preferred embodiment, the 3D objects can also be depicted in a specific color or colored shade thereof in order to specifically highlight certain information content.

In a final method step, the synthesized virtual image 40, or parts thereof, is displayed on a display device 50, where a conflation of the digital image of the defined real 3D object space (real image) and the synthesized virtual image 40 takes place. Here it is decided whether the conflation of the real and the synthesized virtual image 40 is to take place on a conventional display device 50, for example an LCD/TFT display, or on a monitor, or rather only a part of the virtual image 40 is to be displayed on a display field—preferably on a front view display.

For the display 50, in order to enable a depiction with the correct level of overlap on the conventional display device, it must be decided, with the aid of the depth values of the digital image of the defined real 3D object space and the synthesized virtual image 40, whether the pixel of the real or virtual image lies closer to the observer at a given pixel position. The respective pixel that is located closer from the view of the observer is depicted on the display device. There thus results a superimposition of the image content with overlapping accuracy.

In a further embodiment, further known methods can be used, alternatively or additionally, to generate the image of the virtual 3D object, for example image rendering, ray tracing etc.

In the case of a display 50 on a translucent display field of a front view display, only the part of the generated virtual 3D object has to be overlaid that was already adapted for integration into the virtual course of the road perspectively and with spatial accuracy, since the real image—in the field of vision of the driver—is already present in the display field of the front view display. Thus, in this case, the depiction of the image content that is not covered by the part of the generated virtual 3D object of the synthesized virtual image 40 is dispensed with.

Also, in this case, during the image synthesis, it has to be decided for each pixel of the display image, with the aid of the Z-buffer, whether the real or the virtual pixel is located closer to the observer at the respective pixel position. Only the pixel of the virtual image that is located closer to the observer is then displayed. If a “real” pixel, which corresponds to the position on the display field of the front view display, is located closer to the observer, the pixel that corresponds to this position on the display field of the front view dis-play is absent.

In the same way as described above, instead of a stereo camera system for the three-dimensional recording of the environment, other systems can also alternatively be used. For example, a camera system with only one camera can also be used, wherein the three-dimensional image of the environment is determined by images recorded at different times and with different camera positions. Likewise, systems can be used which combine classical cameras with ToF (time of flight)-based measuring techniques, laser range scanners or comparable systems.

As an alternative to a display on a classical, two-dimensional display, the display of the augmented reality scene can also take place on a stereoscopic display, wherein, for each eye or each eye position, a synthetic image is generated separately and image synthesis is carried out.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A method for the depiction of virtual objects in vehicle displays using at least one digital image of a defined real 3D object space recorded by a camera, the method comprising:
a first step in which a virtual course of the road is generated by retrieving perspective information from the digital image of the defined real 3D object space;
a second step in which a predetermined virtual 3D object is generated;
a third step in which the generated predetermined virtual 3D object is adapted to the virtual course of the road of the defined real 3D object space perspectively and with spatial accuracy; and
a fourth step in which the adapted virtual 3D object is integrated into the virtual course of the road of the defined real 3D object space.

12. The method of claim 11, comprising a further step of:
synchronizing a virtual environmental model of the defined real 3D object space with the virtual course of the road from the first step.

13. The method of claim 11, wherein the recorded digital image and the adapted virtual 3D object are displayed on a display device with an accurate level of overlap.

14. The method of claim 11, wherein the adapted virtual 3D object integrated into the fourth step of the method is displayed on a display field of a front view display.

15. The method of claim 14, wherein a display content on the display field of the front view display corresponds to the recorded digital image.

16. The method of claim 11, wherein a respective depth value of a pixel of the digital image is used to retrieve perspective information about the digital image.

17. The method of claim 11, wherein to generate the virtual course of the road in the first step, further information regarding a position of the camera, vehicle surroundings, or map data are alternatively or additionally incorporated.

18. The method of claim 12, wherein the synchronization of the virtual environmental model of the defined real 3D object space uses navigation data of the vehicle or an edge detection.

19. The method of claim 11, wherein in the second step of the method at least one further predetermined virtual 3D object is generated on the basis of further information.

20. A device, comprising:
at least one camera configured to record a digital image of a defined real 3D object space;
a device configured to
generate a virtual course of the road by retrieving perspective information from the digital image of the defined real 3D object space,
generate a predetermined virtual 3D object,
adapt the generated predetermined virtual 3D object to the virtual course of the road of the defined real 3D object space perspectively and with spatial accuracy, and
integrate the adapted virtual 3D object into the virtual course of the road of the defined real 3D object space to produce processed information; and
at least one display device configured to display the processed information.
